(19) United States
(12) Patent Application Publication
(10) Pub. No.: US 2006/0290505 A1
(43) Pub. Date: Dec. 28, 2006

(54) RFID tire label

(76) Inventors: Kevin Conwell, Fairfield, OH (US); Matt Adams, Mason, OH (US)

Correspondence Address: Orum & Roth LLC;Ste 1616, 53 W Jackson Blvd, Chicago, IL, 60604, US

(21) Appl. No.: 11/365,793

(22) Filed: Mar. 1, 2006

Related U.S. Application Data
(60) Provisional application No. 60/657,876, filed on Mar. 1, 2005.

(51) Int. Cl. G06K 7/00; G08B 13/14

(52) U.S. Cl. 340/572.1; 235/435

(57) ABSTRACT

A smart RFID tire label in which the RFID antenna base film is the label face sheet. The antenna pattern, chip and pressure sensitive adhesive are on one side of the base film. This side is applied against the tire surface. The antenna base film acts as the durable label material protecting the antenna and chip from harsh environments associated with tire manufacturing and the wheel/chassis assembly process. The label may be large enough to seal the RFID insert when the label is attached to a tire, thus further protecting the RFID insert from damage.

This application claims the benefit of U.S. Provisional Application No. 60/657,876 filed 1 Mar. 2005 entitled RFID tire label.

### BACKGROUND OF THE INVENTION

1. Field of the Invention

The present invention relates to a tire-tracking label. Specifically, it relates a tire tracking label where the antenna base film forms the label.

2. Description of the Prior Art

In 2000 the National Highway Traffic Safety Administration (NHSTA) pressured several automobile manufacturers to recall thousands of tires because of tread separation on passenger tires. Suspect lots were traced back through the tire manufacturer's quality records, but no records existed in the vehicle chassis assembly process to link tire serial numbers to the vehicle identification number (VIN). Legislation passed by Congress and the Department of Transportation (DOT) now requires automobile manufacturers to implement a tracking system to link the DOT code for each tire to the VIN as mandated by the Transportation Recall Enactment, Accountability, and Documentation (TREAD) Act.

Historically, tire manufacturers relied on hand stamping tires with lot and date codes using indelible ink. Other methods included the use of “bumpy bar codes”, raised bar code symbols directly embossed or molded into the surface of a tire. Unfortunately, these systems are limited in data storage and do not provide the flexibility of on-demand variable data.

Tire and automobile manufacturers are now being pressured to implement a more reliable and accurate method of tracking the DOT code, tire serial numbers, size, type, conicity, date, manufacturing plant, even the mold machine for every tire, and that this data be tied to the VIN.

The Automotive Industry Action Group (AIAG) published a B-11 guideline titled “Tire and Wheel Label and Radio Frequency Identification (RFID) Standard” which identifies a recommended tire tracking system using either a pressure sensitive label printed with a two-dimensional bar code symbol or an RFID tire tag to electronically transfer DOT data and/or a unique identifier from the tire to wherever it is needed, even after the tire is assembled to the wheel, and the tire/wheel assembly is mounted to the vehicle chassis.

One prior art tire label is an identification label permanently affixed to the inner liner of a green uncured (unvulcanized) tire for tracking serial numbers throughout the entire life of the tire up to and including retread. Desired letters and numbers are cut from a 5-20 mil thick sheet of a white pigmented SPBD/rubber blend and then permanently affixed to the inside of a tire once it is cured in a mold through the heat and pressure in the vulcanization curing process.

Another prior art tire label is a tire production control label using a film-type substrate formed of a heat-resistant resin. An information indicating surface onto which a recognizable indication indicating specified information is printed is formed on one surface of the substrate, and a pressure sensitive adhesive layer is formed via a primer layer on the other surface of the substrate. The information indicating surface is formed so as to have a bar code, characters, figures, symbols or drawings on the indicating surface. With the information indicator formed in this way, the indication does not become blurred or erased even under the high temperatures and high pressures during vulcanization.

Another prior art method for supplying a graphic label uses a label that is readable with a light scanning device. The label is placed on a rubber article such as a tire surface. The graphic bar code label is optically interpreted with a bar code reader. Thus, the cured substrate with the label with the graphic message is produced by using thermal transfer techniques.

Another prior art tire label is designed to be disposed on an unvulcanized raw rubber tire and then fixed to the finished tire by vulcanization using heat and pressure. The indication label having a label base material with a heat-resistant plastic film and an abrasive surface coating layer formed on the upper surface of the plastic film. The abrasive surface being composed of a hardened resin and filler. An indication defined by an ink layer is disposed on the abrasive surface. A rubber adhesive laminated on the lower surface of the plastic film adheres the label to the tire. The label is constructed by forming the ink layer on the exterior side of the abrasive surface coating layer. The abrasive surface having a profile and roughness for preserving the quality of the indication.

Another prior art tire identification method uses magnetically encodable tags in tape format written sequentially with tire identifying data and applied to the sidewall material of a green tire. This technology allows the encoded data to be read from the tire at any point in the tire manufacturing process and the signals indicative of the tire identification number converted to an alphanumeric display and/or fed to a process control computer for on-line quality assurance and control or stored as a recorded history of the tire manufacturing process for inventory control.

Passive radio frequency identification (RFID) transponder tags is a technology that can be utilized to track tires. The prior art label design utilizes an integrated circuit chip and antenna embedded within the tire structure that transmits a digital data signal in response to interrogation by an R/F electromagnetic field emanating from outside of the tire.

There are several drawbacks with the prior art RFID labels. RFID labels are expensive. It is very important for the tire tracking system to be inexpensive yet reliable and effective. There is a need for an inexpensive, reliable tire tracking system.

Prior art tire tags using pressure sensitive adhesive resulted in sticky unsightly adhesive residue on the tire sidewall when the label has been removed. This is unappealing to customers and requires additional time and labor to remove the residue. There is a need for a tire label that does not leave a residue when it is removed from the tire and that does not leave any damaging marks or crack on the sidewall that would impact the functional performance or integrity of the tire.

During tire assembly the tires are subjected to handling, wheel mounting, load simulation, and are exposed to fluids like lube and soap. There is a need for a label which will protect the RFID tag from damage. There is also a need for a tag which mounts the integrated circuitry/antenna against the tire surface to minimize the chance it will be damaged.

Plasticizers and other low molecular weight additives within the rubber tire compound migrate to the tire surface. These migratory components can damage or stain the label, and can weaken the bonds of some adhesives and may damage the RFID. Thus, there is a need for a tire label with an adhesive or barrier layer to resist compound migration.

There is a need for a label that does not have the RFID tag inlay inserted or sandwiched into the label. There is a need for a label that can withstand the stress of tire manufacture but be manufactured at a low cost.

There is a need for a tire tracking system that is inexpensive yet reliable and effective.

### SUMMARY OF THE INVENTION

Radio frequency transponders (also known as “RFID tags”) generally include an antenna and integrated memory circuit with read/write capability used to store digital information, such as an electrically erasable programmable read only memory (EEPROM) or similar electronic device. Active RFID tags include their own radio transceiver and power source (battery) and are generally sealed within a molded plastic housing or “button”. Passive RFID tags are energized to transmit and receive data by an electromagnetic field and do not include a radio transceiver or power source. As a result they are small and inexpensive with limited range, resolution, and data storage capacity. Passive RFID tag “inlays” or “inlets” used in the Automatic Identification Industry are typically laminated or inserted into a paper or plastic label stock backed with pressure sensitive adhesive for applying the printed label to a carton, pallet, airline baggage, parcel, or other article to be tracked. These labels are commonly referred to as “smart labels”.

The RFID label provides fast, reliable, accurate data collection without human error or replication. A pressure sensitive adhesive provides a simple means of affixing the RFID label to either the interior or exterior surface of a tire without being labor intensive. Placement of the RFID label on the outside of the tire allows for easy access and removability at final wheel/chassis assembly once the data is linked to the VIN database. The RFID label and adhesive system does not leave any damaging marks or surface cracks on the sidewall that would impact the functional performance or the integrity of the tire.

Rather than having a tire label with an RFID tag inlay inserted or sandwiched under the label, the inventive design utilizes the antenna base film as the actual label. The antenna base film thickness is preferably 0.002 to 0.020 inches. If necessary, a thicker film could be used depending on the application. The film could be clear, white, pigmented, dyed or printed. A polyamide base film (such as Dupont Kapton) is preferably used because it can withstand high solder temperatures when the antenna leads are attached to the MSOP integrated circuit chip. Other antenna base films that are less expensive than polyamide could be used to reduce cost, such as polyester. Polyester does not provide the same high temperature resistance that polyamide provides. It is suitable in situations, such as where the integrated circuit (IC) mounting is done with flip-chip technology using a conductive epoxy to bond the IC to the antenna.

The antenna pattern, chip and pressure sensitive adhesive are on one side of the base film. This side would be applied against the tire surface. The antenna base film acts as the durable label material protecting the antenna and chip from harsh environments associated with tire manufacturing and the wheel/chassis assembly process. The tire manufacturing and assembly environments typically include warehouse storage, handling, shipping, trailers, conveyors, soaping, wheel mounting equipment, inflation, balancing, and load simulator equipment. Some machines used for wheel mounting and load simulation actually contact the tire sidewall and RFID label, putting stress on the tire, label and the chip.

This inventive RFID tire label is attached with a pressure sensitive adhesive to the outer surface of a tire sidewall for use in automating the collection of information through the wheel mounting and final assembly processes.

A “smart label” with an embedded RFID insert coated on one side with a pressure sensitive self-adhesive for attachment to a tire would easily allow for a readily available RFID technology to be utilized in tracking tires.

A solid, tough label film used in the preferred configurations to protect the integrated circuit and antenna from damage incurred during handling, wheel mounting, and load simulation. A solid film label also protects of the RFID from fluids including the lube and soap stations encountered during wheel assembly.

To resist plasticizer migration, a higher coat weight of adhesive can be used which coat weight achieves a stable bond. A higher coat weight of adhesive maintains a more secure bond at the adhesive-film interface as plasticizers and other low molecular weight additives within the rubber tire compound migrate to the tire surface and through the adhesive. The thicker adhesive will act as a reservoir for equilibrium of component migration.

A soft film of low stiffness is preferred as it allows the label to quickly conform to the sidewall and tread irregularities including conforming over variations in surface height such as those created by raised lettering, serrated patterns, and vent ports.

### BRIEF DESCRIPTION OF THE FIGURES

FIG. 1 is a first embodiment of a tire label.

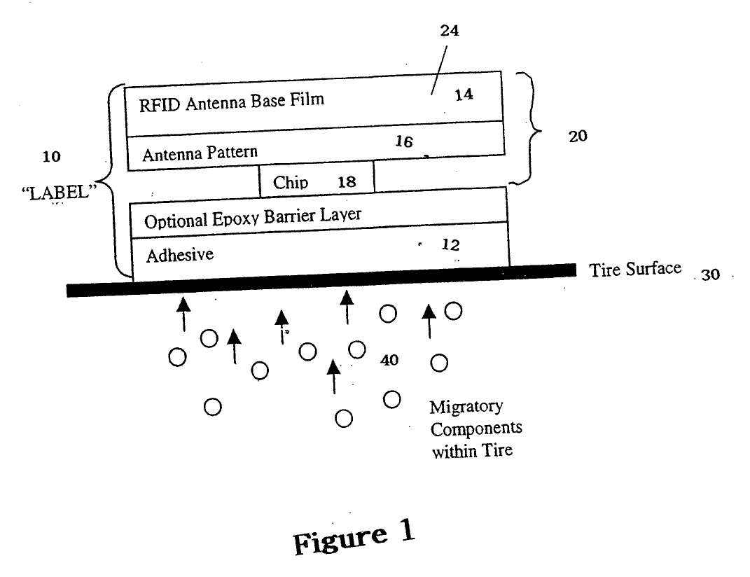

FIG. 2 is a second embodiment of a tire label.

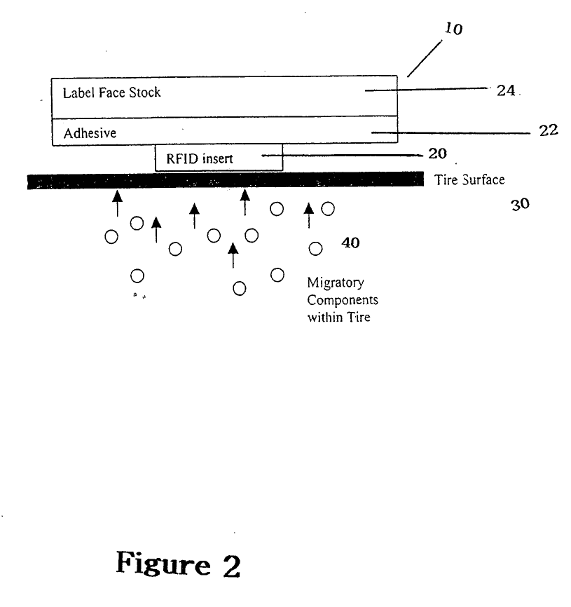

FIG. 3 is a die cut label web.

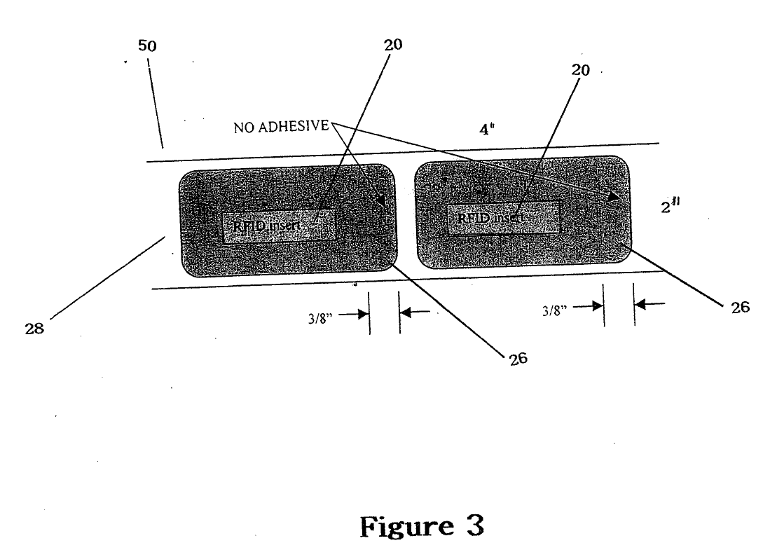

FIG. 4 is a chart showing adhesive peel strength over time.

FIG. 5 is an alternative tire label.

### DETAILED DESCRIPTION OF THE INVENTION

Radio frequently transponders (also known as “RFID tags”) 20 generally include an antenna 16 and integrated memory circuit 18 with read/write capability used to store digital information, such as an electrically erasable programmable read only memory (EEPROM) or similar electronic device. Active RFID tags 20 include their own radio transceiver and power source (battery) and are generally sealed within a melded plastic housing or “button”. Passive RFID tags 20 are energized to transmit and receive data by an electromagnetic field and do not include a radio transceiver or power source. As a result they are small and inexpensive with limited range, resolution, and data storage capacity. Passive RFID tag “inlays” or “inlets” 20 used in the Automatic Identification Industry are typically laminated or inserted into a paper or plastic label stock backed with pressure sensitive adhesive for applying the printer label to a carton, pallet, airline baggage, parcel, or other article to be tracked. These labels are commonly referred to as “smart labels”.

RFID labels 10 provide fast, reliable, accurate data collection without human error or replication. A pressure sensitive adhesive 12 provides a simple means of affixing the RFID label 10 to either the interior or exterior surface of a tire 30 without being labor intensive. Placement of the RFID label 10 on the outside of the tire 30 allows for easy access and removability at final wheel/chassis assembly once the data is linked to the VIN database. The RFID label 10 and preferred adhesive 12 does not leave any damaging marks or surface cracks on the sidewall that would impact the functional performance and integrity of the tire 30.

Rather than having a tire label with an RFID tag inlay inserted or sandwiched under the label, in a first embodiment the antenna base film 14 is used as the label film 24. The antenna base film 14 thickness is preferably 0.002 to 0.020 inches. If necessary, a thicker film 14 could be used depending on the application. The film could be clear, white, pigmented, dyed or printed. Film 14 is preferably a polyamide film (such as Dupont Kapton) that can withstand high solder temperatures when attached with the antenna 16 leads to the chip 18. The chip 18 is preferably a MSOP integrated circuit chip. Other antenna base films 14 that are less expensive than polyamide can be used to reduce cost, such as polyester. Polyester does not provide the same high temperature resistance that polyamide provides. Thus, it would be suitable for other IC mounting techniques such as flip-chip technology using a conductive epoxy cement or underfill to bond the IC 18 to the antenna 16.

The antenna pattern 16, chip 18 and pressure sensitive adhesive 12 are on a first side of the base film 14. This first side is applied against the tire surface 30. The antenna base film 14 acts as the durable label material protecting the antenna 16 and chip 18 from harsh environments associated with tire manufacturing and the wheel/chassis assembly process. The tire manufacturing and assembly environments typically include warehouse storage, handling, shipping, trailers, conveyors, soaping, wheel mounting equipment, inflation, balancing, and load simulator equipment. Some machines used for wheel mounting and load simulation actually contact the tire sidewall and RFID label, putting stress on the tire, label and chip.

Utilizing antenna base film 14 as the label base film eliminates the additional cost of having a tire label 10 with a separate RFID tag inlay inserted or sandwiched into the label 10. Using a less expensive antenna base film 14 also reduces the cost. A polyamide base film is preferably used because it can withstand high solder temperatures and sonic welding when attaching the antenna 16 leads to the MSOP integrated circuit chip 18. This base film 14 is very expensive and overkill for some labels 10.

Other antenna base films 14 such as polyester or polystyrene may be used to reduce cost when the IC mounting is done with flip-chip technology using an electronically conductive cement, epoxy, or underfill to bond the IC 18 to the antenna pattern 16. Polyester provides a more stable adhesive bond over other film types like polypropylene. A solid polyester film helps maintain a secure bond at the adhesive-film interface as plasticizers and other low molecular weight additives within the rubber tire compound migrate to the tire surface and through the adhesive. The adhesive could also be designed to prevent or minimize migration. The adhesive 12, 22 selected for label attachment is preferably a pressure sensitive rubber based system coated at a thickness of 0.001 to 0.010 inches. If necessary, thicker adhesive could be used depending on the tire surface 30. It is designed to provide a strong bond between the RFID label 10 and tire surface 30, yet be removable after the final wheel/chassis assembly. Any adhesive residue remaining on the tire surface can easily be cleaned off with heptane or citric based cleaner. The pressure sensitive adhesive can be of a rubber based chemistry, acrylic polymer, or modified blend of these.

The adhesive system may optionally also have a barrier layer (not shown) utilizing a high polarity chemistry to inhibit diffusion and migration of non-polar components such as low molecular weight plasticizer (e.g. low polarity type) and oil ingredients meeting this criteria would be polyester materials such as polyethylene napthalate (PEN) and polyethylene terpthalate (PET).

The adhesive 12, 22 could also be a heat activated, UV-curable, epoxy, or silicone type system. An epoxy adhesive compound provides the tightest barrier layer being substantially impervious to migratory tire components from attacking the RFID label. An epoxy barrier layer 19 could also be provided between the antenna base film and adhesive layer to prevent migratory tire components 40 from attacking the RFID label. This construction will resist migration of mobile species such as waxes, oils, lubricants, plasticizers and other low molecular weight additives from within the tire to the adhesive-film interface. Other such tire components 40 includes plasticized sulfur, hydrogen sulfide and oil for maintaining a flexible, elastomeric product after vulcanization.

The base film is exposed and the IC/antenna against the tire surface. Thus, the solid, tough, hard antenna base film 12 protects the IC 18 and antenna 16 from damage incurred during handling, wheel mounting, and load simulation.

Release liner 28 could be used to protect the adhesive prior to use. Release liner could be constructed of either paper or film preferably having 28 a thickness of 0.001 to 0.004 inches. Release liner 28 could be thinker if necessary for the application. The side contacting the adhesive 12, 22 is coated with a release layer, typically a cured silicone or similar coating designed to release from the pressure sensitive adhesive 12, 22. The backside can also be coated with a similar release layer to prevent blocking (sticking) of the roll wraps if there is adhesive bleed around the edges of the tire labels. The tire labels can be manufactured in a roll or fan folded configuration. The label 10 configuration can be provided with singulated labels on the web, or in a continuous web (non-singulated) to be manually or automatically cut. Each RFID tire label 10 can be either manual peeled from the release liner and applied by hand to a tire surface, or automatically applied. The “top” side of the antenna base film opposite the IC/antenna 18, 16 could be designed with a release coating to prevent the adhesive from sticking in a self wound “linerless” form, eliminating the need for a separate release liner when wound up un roll form. The base film color or “top” side of the antenna base film opposite the IC/antenna may be color coded for visible identification, or carry printed indicia. In another embodiment the antenna base film could include security features such as slits (not shown) around the edges to deter tampering or removal.

In an alternative embodiment, a label based film 24 is coated on a first side with a rubber-based adhesive 22 as a means of attaching an RFID insert 20 to a tire surface 30. Label 10 is preferably oversized to seal and bond to the tire 30 around the RFID insert 20, providing a tight, secure bond resistant to fluids. Label film 24 could be vinyl, polyethylene, polypropylene, polyester, polyamide, or any stable solid plastic film with low stiffness properties for conforming to sidewall and tread irregularities. Label film 24 may be RFID 20 base film 14. Label film 24 shall be durable enough to provide protection for the antenna and chip circuit from harsh environments associated with tire manufacturing and the wheel/chassis assembly process. The tire manufacturing and assembly environments typically include warehouse storage, handling, shipping, trailers, conveyors, soaping, wheel mounting equipment, inflation, balancing, and load simulator equipment. Some machines used for wheel mounting and load simulation actually contact the tire sidewall and RFID label, putting stress on the tire and label as shown in the following mounting and inflation equipment pictures.

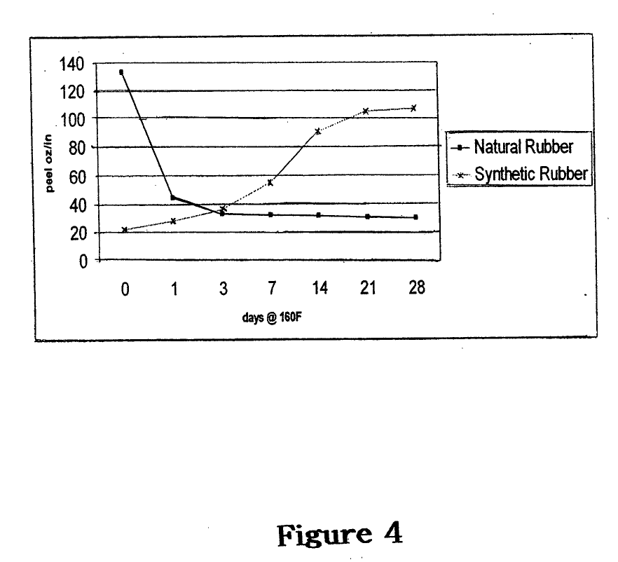

Adhesive 22 thickness should be between 3-6 mils, but thickness can be more or less depending upon the desired adhesion level. It shall provide a strong enough bond between RFID label 10 and tire surface 30, yet removable after the final wheel/chassis assembly. The adhesive 12, 22 could be any blend or combination of natural or synthetic rubber, tackifiers and antioxidants designed to adhere to vulcanized butyl rubber. A synthetic rubber based adhesive 12, 22 is preferred over a natural rubber adhesive for stability. As shown in FIG. 4, as natural rubber adhesives age, contamination from low molecular weight components migrating to the tire surface will decrease the adhesion bond. Natural rubber adhesives are also prone to oxidation and will tend to dry out over time, loosing their tack as shown in the aging chart below.

Release liner 28 may be used to protect adhesive 12, 22 prior to use. Tire labels 10 can be manufactured in a roll or fanfolded configuration. Label configuration can be provided with singulated labels on the web 50, or in a continuous web (non-singulated) to be manually or automatically cut. Each RFID tire label 10 can be either manual peeled from the release liner 28 and applied by hand to a tire surface 30 or automatically applied.

Labels 10 may be of a variety of shapes and sizes. In one embodiment, labels 10 are approximately 4″×2″, but are not limited to this size. Each label 10 may have a dry pull tab 26 along one edge to facilitate easy removal. Pull tabs 26 are free from adhesive 12, 22. Pull tabs 26 preferrably are of sufficient size that they can be grasped easily. For example, a 4 inch by 2 inch label 10 may have a ¾ inch pull tab 26 running the width of label 10.

Pull tabs 26 may be readily identified by a printed arrow, mark, color, or other method of visible detection. Each label 10 attached to the outer surface of a tire can contain a single RFID insert 20, or multiple RFID inserts 20.

Smart labels 10 can be manufactured with RFID inserts 20 already embedded in the label, or RFID inserts 20 can be introduced to the label at the time it is applied to the tire surface 30. Labels 10 may be manufactured with some amount of pressure sensitive adhesive on the back side of the RFID insert to improve the bond to tire surface 30.

Label 10 may be transparent, opaque, dyed, or printed. It may be white, blue or any other color. Label surface may be printable. Label face stock 24 may be a clear film to allow for RFID insert 20 visibility. Insert may contain printed identification visible through clear film in case of electronic failure.

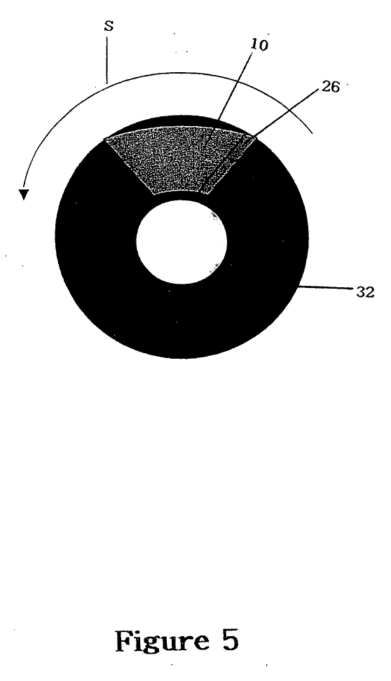

Labels 10 are not limited to the rectangular shape. They may be cut in an arc shape as shown in FIG. 5 to better follow the shape of a curved sidewall 32. An arch shaped label 10 with a pull-tab 26 along on side ensures pull tab 26 is positioned at the back of label 10 as a tire rotates S in tire uniformity optimizer (TUO) and load simulation machines, otherwise the pull tab 26 will lift and peel. In a label 10 with rectangular or square form pull tab 26 may not always be positioned at the back end of label 10 as the tire rotates S. The arc label 10 and pull tab 26 are preferably manufactured so that pull tab 26 is always oriented at the trailing end of label 10 on the tire as tire spins S.

1. A smart label comprising:
a label film, having a first side and a second side,
an adhesive layer on the first side of the label film, and
an RFID between the label film and the adhesive, said RFID comprising an RFID antenna and an integrated circuit; and
wherein the label film is an RFID antenna base film, the RFID antenna pattern is printed on the first side of the label film.

2. The smart label of claim 1 wherein the RFID antenna base film is a polyamide film.
